(19) United States
(12) Patent Application Publication
(10) Pub. No.: US 2005/0140066 A1
(43) Pub. Date: Jun. 30, 2005

(54) Particulate core preforming process

(76) Inventors: Mark Oliver, Auckland (NZ); Oliver Charles Graham Jackson-Hill, Hamilton (NZ)

Correspondence Address: LADAS & PARRY LLP, 224 SOUTH MICHIGAN AVENUE, SUITE 1200, CHICAGO, IL, 60604, US

(21) Appl. No.: 10/747,435

(22) Filed: Dec. 29, 2003

(51) Int. Cl. B27N 1/00

(52) U.S. Cl. 264/510; 264/517

(57) ABSTRACT

A method of fabricating a preformed core material by utilizing a particulate preform process. The particulate core material is combined with an adhesive binder and deposited upon a porous surface, through which air is drawn, having the desired preform shape. Once the adhesive sets the deposited layer of core material is removed from the porous surface and may be used as a core in a closed molding process. This method may also be used to fabricate a preformed laminate by depositing layers of fiber material before and/or after a core material is deposited.

### FIELD OF THE INVENTION

The present invention relates generally to a particulate preforming process. More specifically, the present invention relates to a particulate preforming process to provide a core of filler material.

### BACKGROUND OF THE INVENTION

In a conventional preforming process, fibers and a binder are sprayed onto a porous surface, typically a screen, through which air is drawn. The fibers are held to the screen by the binder and the suction force of the air. Once the binder sets, the layer of fibers which has formed on the screen may be removed. The binder is typically an adhesive which could be in an emulsion or powder form. Emulsions may dry partially due to the airflow of the suction fan, whereas the powder form may require subsequent heating to activate the adhesive properties.

The preforming process allows the formed layer to be made in intricate shapes, including complex three-dimensional shapes. Typically the preform comprises a fiber material, such as fiberglass, which is later combined with a resin in a closed molding process. Examples of closed molding processes include resin transfer molding (RTM), RTM light, vacuum infusion molding and injection compression molding.

Fiber material used in preforming is relatively expensive as are the resins that are used in the molding process. When a thick preformed piece is desired, a core material may be used between preformed fiber layers taking advantage of the respective material strengths or the resin flow properties, and reducing the amount of fiber material and resin which is needed to form a finished part. Furthermore, if the strength of the fiber material is not needed, the core may be used alone. It was, however, previously unknown how to inexpensively provide the core material in the desired intricate shapes. The core materials were previously added to a laminate from a flat sheet or roll stock material, or a complex three-dimensional insert. Cores could be added to a laminate for use in an open or a closed molding environment. Thus, the need exists for a low cost method of providing core materials for products having intricate shapes.

It is also common practice to use filler materials in conjunction with resins. The filler materials may offer many advantages such as reduced cost of the resin composition, increased strength, lower weight, increased durability, modified stiffness, increased flexibility, fire retardancy, modified acoustical properties, etc. Since resins typically are very expensive, of great concern is the cost savings the use of fillers may provide.

### SUMMARY OF THE INVENTION

The present invention is the application of the preforming process to use particles to form a core layer, either alone or in conjunction with layers of fiber material as a laminate. The advantage of using the particulate preforming process is the ability to selectively deposit core materials so that the core may be formed in intricate two or three-dimensional shapes at a relatively low cost.

### DETAILED DESCRIPTION OF THE PREFERRED EMBODIMENTS

The particulate preform process utilizes a core material, which is applied by depositing the core materials on a preformed porous surface such as a screen. The core material is first supplied in particulate form. Examples of suitable core materials include recycled plastics, aggregates, minerals and plant-based materials. The core material may be cut-up or chopped-up to provide the desired particulate size.

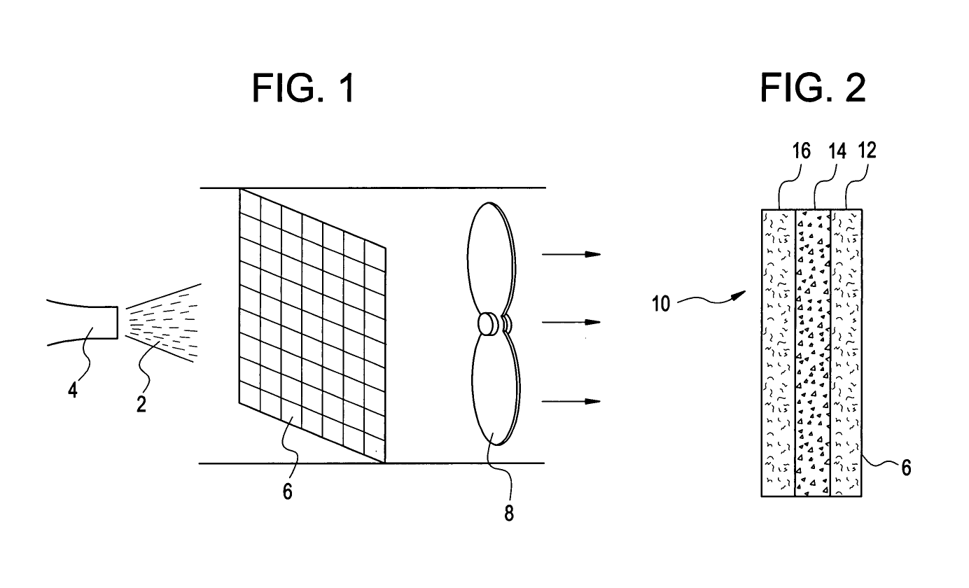

As shown in FIG. 1, the core material 2 is sprayed or blown through a nozzle 4. The core material 2 is also combined with an adhesive binder. The adhesive binder may be combined with the core material 2 and both sprayed together through a single nozzle 4, or the adhesive may be sprayed through a separate nozzle (not shown) in conjunction with the spraying of the core material 2. The adhesive binder is typically a weak adhesive, and is supplied in a liquid emulsion or a heat-curable powder form.

Air is drawn through a screen 6, by means such as a fan 8, so that the combined core material and adhesive are deposited upon, and form a layer on, the screen 6. The air being drawn through the screen creates a vacuum side of the screen, onto which the filler material and adhesive are deposited and partially held in place on the screen by the vacuum effect. The screen is in the shape of the finished article that is to be made. The particulates must be made large enough so that they are not drawn through the screen 6.

As shown in FIG. 2, a laminate 10 may also be made by the particulate preforming process by either laying a woven fiber mat down over the screen 6 or by forming a layer of fibers by spraying fibers or filaments against the screen with the weak adhesive. The fibers when sprayed are randomly deposited to form a non-woven layer. A typical laminate consists of a first fiber layer 12, a middle core layer 14, and a second fiber layer 16.

The fibers (typically fiberglass) used to form the fiber layers add strength to the laminate 10.

A preferred adhesive for this preforming process is a vinyl acetate homopolymer resin emulsion under the tradename VISCOPOL® 6624, manufactured by Nuplex Industries Limited of New Zealand. This emulsion is supplied with a 42% solids content which is diluted with water down to a 25% solids content. To bind glass fibers together, 1.8% by mass of the diluted emulsion is used in relation to the mass of the glass fiber. To bind a core material such as wood chips together, 4.6% of the diluted emulsion is used in relation to the mass of the wood chips. This is merely a preferred use of a binding adhesive and it is recognized that other variations on the type and amount of adhesive used is also possible.

Once the adhesive binder has set or cured, the preformed core or laminated core may then be removed from the screen and placed in a mold for resin to be applied. The preform holds its shape due to the adhesive binder, which also was applied. Further compression of the preform may occur during the closure of the mold or the resin-filling phase of the process. The resin is typically applied to the preform in the mold by a closed molding process such as a resin transfer molding process, RTM light, vacuum infusion, or an injection compression molding process. A typical resin that is used in the molding process is polyester resin, though the process is not limited to the use of this resin.

As will be apparent to those skilled in the art to which the invention is addressed, the present invention may be embodied in forms other than those specifically disclosed above, without departing from the spirit or essential characteristics of the invention. The particular embodiment of the invention described above and the particular details of the processes described are therefore to be considered in all respects as illustrative and not restrictive. The scope of the present invention is as set forth in the appended claims

1. A method of fabricating a preformed core material comprising the steps of:
providing a porous surface in a desired shape of the preformed core;
drawing air through the porous surface; and
depositing a combination of particulate core material along with an adhesive binder onto a vacuum side of the porous surface.

2. The method of claim 1 further comprising the initial step of providing the core material in particulate form.

3. The method of claim 1 further comprising the step of depositing a first layer of fiber material onto the vacuum side of the porous surface before the mixture of particulate core material and adhesive binder is deposited.

4. The method of claim 3 wherein said first layer of fiber material is a non-woven fiber mat.

5. The method of claim 3 wherein said first layer of fiber material is a woven fiber mat.

6. The method of claim 3 wherein said first layer of fiber material is deposited as a mixture of fiber material and adhesive.

7. The method of claim 3 further comprising the step of depositing a second layer of fiber material onto the vacuum side of the porous surface over the mixture of particulate core material and adhesive

8. The method of claim 1 wherein a layer of the mixture of particulate core material and adhesive is deposited between at least two layers of a fiber material.

9. The method of claim 1 wherein the porous surface is a screen.

10. The method of claim 1 further comprising the step of setting the adhesive.

11. The method of claim 10 further comprising the step of removing the preformed core of filler material from the porous surface.

12. The method of claim 7 wherein said first and second layers of fiber material, are deposited as a mixture of particulate core material and adhesive binder; and further comprising the steps of setting the adhesive binder mixed with the core and fiber materials, and removing the set core and fiber materials from the porous surface.

13. The method of claim 1 wherein the core material is selected from the group consisting of plastic, aggregates, minerals and plant-based materials.

14. The method of claim 3 wherein said fiber material is fiberglass.

15. The method of claim 1 wherein the adhesive binder is a liquid emulsion.

16. The method of claim 1 wherein the adhesive binder is a heat-curable powder.

17. The method of claim 15 wherein the liquid emulsion is a vinyl acetate homopolymer resin emulsion.

18. A method of molding a preformed article comprising the steps of:
providing a porous surface in a desired shape of the preformed article;
drawing air through the porous surface;
depositing a mixture of particulate core material and adhesive binder onto a vacuum side of the porous surface to form a core of material;
setting the adhesive;
removing the core material from the porous surface;
placing the core material in a mold; and
adding resin into the mold.

19. The method of claim 18 wherein said article is molded by a closed molding process.

20. The method of claim 19 wherein said closed molding process is one selected from the group consisting of resin transfer molding, resin transfer molding light, vacuum infusion molding and injection compression molding.

21. The method of claim 18 further comprising the steps of:
depositing a first fiber layer onto the vacuum side of the porous surface before the mixture of particulate core material and adhesive is deposited; and
depositing a second fiber layer onto the vacuum side of the porous surface over the mixture of particulate core material and adhesive.

22. The method of claim 21 wherein said first and second fiber layers are deposited as a combination of fiber material and adhesive binder.

23. The use of a core of particulate core materials, formed by depositing a mixture of the particulate core materials and an adhesive onto a porous surface through which air is drawn, in a closed molding process.
